(19) United States
(12) Patent Application Publication
(10) Pub. No.: US 2025/0030543 A1
(43) Pub. Date: Jan. 23, 2025

(54) EFFICIENT POINT VERIFICATION FOR SEMI-STATIC ELLIPTIC CURVE DIFFIE-HELLMAN AUTHENTICATION PROTOCOLS

(71) Applicant: NXP B.V., Eindhoven (NL)

(72) Inventors: Mario Lamberger, Graz (AT); Bruce Murray, Eastleigh (GB)

(21) Appl. No.: 18/356,403

(22) Filed: Jul. 21, 2023

(51) Int. Cl. H04L 9/30

(52) U.S. Cl. CPC H04L 9/3066; H04L 9/3013

(57) ABSTRACT

An elliptic curve point validation method, comprising: receiving a standard projective X and Z coordinate on an elliptic curve; computing X·Z; inverting X·Z to get (XZ)⁻¹; multiplying Z², (XZ)⁻¹, and a constant \sqrt{b} resulting in \sqrt{b}·x⁻¹, where b is a constant of the elliptic curve; multiplying X² and (XZ)⁻¹ resulting in x; computing Tr(x) and checking that it has a value of 1, where Tr(⋅) is a trace of Frobenius map that maps an input to a value of 0 or 1; computing Tr(\sqrt{b}x⁻¹) and checking that it has a value of 0; and outputting x and a PointOnCurve value, where the PointOnCurve value indicates whether x is on the elliptic curve.

### FIELD OF THE DISCLOSURE

Various exemplary embodiments disclosed herein relate to efficient point verification for semi-static elliptic curve Diffie-Hellman (ECDH) authentication protocols.

### BACKGROUND

Authentication protocols are a vital building block in virtually every secure system nowadays. In resource constrained environments, design decisions need to be made to achieve the security requirements based on minimal assumptions. The ECDH protocol is a versatile tool with many applications in cryptography. It can for example be used for offline authentication that is an important process in any supply chain and consumables use-case. The complexity of this problem is usually based on the fact that significant resource constraints on the prover side have to be dealt with, where chip area and energy consumption are guiding factors.

### SUMMARY

A summary of various exemplary embodiments is presented below.

An elliptic curve point validation method, including: receiving a standard projective X and Z coordinate on an elliptic curve; computing X·Z; inverting X·Z to get (XZ)⁻¹; multiplying Z², (XZ)⁻¹, and a constant \sqrt{b} resulting in \sqrt{b}·x⁻¹, where b is a constant of the elliptic curve; multiplying X² and (XZ)⁻¹ resulting in x; computing Tr(x) and checking that it has a value of 1, where Tr(⋅) is a trace of Frobenius map that maps an input to a value of 0 or 1; computing Tr(\sqrt{b}x⁻¹) and checking that it has a value of 0; and outputting x and a PointOnCurve value, where the PointOnCurve value indicates whether x is on the elliptic curve.

Various embodiments are described, further including setting PointOnCurve to true when Tr(x) has a value of 1 and Tr(\sqrt{b}x⁻¹) has a value of 0.

Various embodiments are described, further including setting PointOnCurve to false when either Tr(x) has a value of 1 or Tr(\sqrt{b}x⁻¹) has a value of 0.

Various embodiments are described, further including calculating a square of X.

Various embodiments are described, further including calculating a square of Z.

Further various embodiments relate to a data processing system including instructions embodied in a non-transitory computer readable medium, the instructions for an elliptic curve point validation method based on an elliptic curve in a processor, the instructions, including: receiving a projective X and Z coordinate on the elliptic curve; computing X·Z; inverting X·Z to get (XZ)⁻¹; multiplying Z², (XZ)⁻¹, and a constant \sqrt{b} resulting in \sqrt{b} ·x⁻¹, where b is a constant of the elliptic curve; multiplying X² and (XZ)⁻¹ resulting in x; computing Tr(x) and checking that it has a value of 1, where Tr(⋅) is a trace of Frobenius map that maps an input to a value of 0 or 1; computing Tr(\sqrt{b}x⁻¹) and checking that it has a value of 0; and output x and a PointOnCurve value, where the PointOnCurve value indicates whether x is on the elliptic curve.

Various embodiments are described, further including setting PointOnCurve to true when Tr(x) has a value of 1 and Tr(\sqrt{b}x⁻¹) has a value of 0.

Various embodiments are described, further including setting PointOnCurve to false when either Tr(x) has a value of 1 or Tr(\sqrt{b}x⁻¹) has a value of 0.

Various embodiments are described, further including calculating a square of X.

Various embodiments are described, further including calculating a square of Z.

Further various embodiments relate to an elliptic curve point validation method, including: receiving a Jacobian projective X and Z coordinate on an elliptic curve; computing (X·Z)²; inverting (X·Z)² to get (XZ)⁻²; multiplying X³ and (XZ)⁻² resulting in x; multiplying Z⁴ and (XZ)⁻² to get Z²·X⁻²; multiplying Z²·X⁻² with X and a constant V resulting in \sqrt{b}·x⁻¹, where b is a constant of the elliptic curve; computing Tr(x) and checking that it has a value of 1, where Tr(⋅) is a trace of Frobenius map that maps an input to a value of 0 or 1; computing Tr(\sqrt{b}x⁻¹) and checking that it has a value of 0; and outputting x and a PointOnCurve value, where the PointOnCurve value indicates whether x is on the elliptic curve.

Various embodiments are described, further including setting PointOnCurve to true when Tr(x) has a value of 1 and Tr(\sqrt{b}x⁻¹) has a value of 0.

Various embodiments are described, further including setting PointOnCurve to false when either Tr(x) has a value of 1 or Tr(\sqrt{b}x⁻¹) has a value of 0.

Various embodiments are described, further including calculating a cube of X.

Various embodiments are described, further including squaring Z twice.

Further various embodiments relate to a data processing system including instructions embodied in a non-transitory computer receiving a projective X and Z coordinate on an elliptic curve; computing (X·Z)²; inverting (X·Z)² to get (XZ)⁻²; multiplying X³ and (XZ)⁻² resulting in x; multiplying Z⁴ and (XZ)⁻² to get Z²·X⁻²; multiplying Z²·X⁻² with X and a constant \sqrt{b} resulting in \sqrt{b}·x⁻¹, where b is a constant of the elliptic curve; computing Tr(x) and checking that it has a value of 1, where Tr(⋅) is a trace of Frobenius map that maps an input to a value of 0 or 1; computing Tr(\sqrt{b}x⁻¹) and checking that it has a value of 0; and outputting x and a PointOnCurve value, where the PointOnCurve value indicates whether x is on the elliptic curve.

Various embodiments are described, further including setting PointOnCurve to true when Tr(x) has a value of 1 and Tr(\sqrt{b}x⁻¹) has a value of 0.

Various embodiments are described, further including setting PointOnCurve to false when either Tr(x) has a value of 1 or Tr(\sqrt{b}x⁻¹) has a value of 0.

Various embodiments are described, further including calculating a cube of X.

Various embodiments are described, further including squaring Z twice.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

The same reference numbers in different drawings may identify the same or similar elements.

FIG. 1 illustrates a graphical description of the ECDH protocol as applied to a reader and a tag.

FIG. 2 illustrates a point verification method that checks whether the point is on the elliptic curve for standard projective coordinates.

FIG. 3 illustrates a point verification method that checks whether the point is on the elliptic curve for Jacobian projective coordinates

FIG. 4 illustrates an exemplary hardware diagram for implementing an authentication protocol.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of authentication systems that verify a point on an elliptic curve will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Authentication protocols are a vital building block in virtually every secure system nowadays. In resource constrained environments, design decisions need to be made to achieve the security requirements based on minimal assumptions. Embodiments of a countermeasure that checks that a point is on a certain elliptic curve is disclosed herein. This is crucial against well-known fault attacks that try to modify a point on an elliptic curve to a point on the quadratic twist of the curve and solve the corresponding discrete logarithm problem on the twist. This can then be mapped back to the original discrete logarithm problem, which thus compromises the private key. The countermeasure disclosed herein has the advantage that it may be neatly integrated with a well-known projective-to-affine transformation, which very often has to be computed anyway.

The ECDH protocol is a versatile tool with many applications in cryptography. It can for example be used for offline authentication which is an important process in any supply chain and consumables use-case. The complexity of this problem is usually based on the fact that significant resource constraints on the prover side need to be dealt with where chip area and energy consumption are guiding factors.

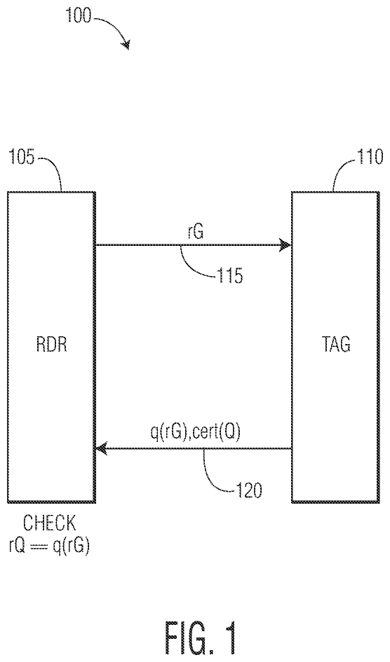

FIG. 1 illustrates a graphical description of the ECDH protocol as applied to a reader and a tag. The reader 105 may act as a verifier, and the tag 110 may act as a prover. The reader 105 randomly generates a value r and multiplies it with a base point G to generate challenge point r G. The challenge point r·G is sent 115 to the tag 110. The tag 110 multiplies the challenge point by its private key q to obtain q(rG) to authenticate itself to the verifier. The tag 110 sends 120 q(rG) back to the reader 105. The tag 110 may also send a certificate for the tags public key Q associated with its private key q. The reader 105 may verify the tag by multiplying the value r with the tags public key Q. The value rQ is then compared to the received q(rG) value. As Q=r·G, if rQ==q(rG) the reader 105 has verified the tag 110.

There are multiple choices that the prover can make in order to implement the elliptic curve scalar multiplication as efficiently as possible. A common method is to use a Montgomery-ladder approach with co-Z projective coordinates (i.e. sharing the same Z-coordinate). In such a version of the protocol, one would only take the x-coordinate of the challenge point as input from the verifier and answer of the prover would also just be the x-coordinate of the result or the projective (X:·:Z) coordinates without the y-coordinate.

One common attack when it comes to elliptic curve cryptography is a so called twist attack. This attack uses the fact that a non-trivial quadratic twist of a given elliptic curve may have a smooth group order, for which a Pohlig-Hellman attack can be applied. The original elliptic curve group and its quadratic twist are isomorphic. That allows an attacker to try and solve the discrete logarithm problem in the twist, which may be feasible, and then map it back to the original curve, which compromises the private key of the tag.

In the scenario of FIG. 1, the users should be aware of such a twist attack as the challenge coming in from a reader may be potentially crafted in a way (by a malicious reader) such that the tag would compute with its private key and the point on the twist. Even in the case of an honest reader, an attacker might use a fault injection attack on the tag to modify the challenge x-coordinate to an x-coordinate on the twist and thus perform the aforementioned attack.

In order to identify whether a presented challenge actually represents a valid point on the agreed and selected elliptic curve, point validity checks have been introduced. In affine form, a given point (x, y) is on the curve if it satisfies the affine elliptic curve equation:

$${y}^{2} + {a}_{1} xy + {a}_{3} y = {x}^{3} + {a}_{2} {x}^{2} + {a}_{4} x + {a}_{6} , \qquad ( 1 )$$

or in case of standard projective coordinates (X:Y:Z) the projective equation:

$${Y}^{2} Z + {a}_{1} XYZ + {a}_{3} {YZ}^{2} = {X}^{3} + {a}_{2} {X}^{2} Z + {a}_{4} {XZ}^{2} + {a}_{6} {Z}^{3} . \qquad ( 2 )$$

As mentioned before, in highly efficient implementations only the x-coordinate of the input point is used during the computation. For each valid x-coordinate, there are two (except for points of order h (cofactor)) y-coordinates that constitute valid points on the elliptic curve.

So the question about whether a challenge x-coordinate is on the elliptic curve is in the affine case a question whether a certain quadratic equation has a solution or not. Actually, the equation does not need to be solved, but rather it just needs to be determined if there is a solution. For binary fields, this may be done rather easily, based on the trace of Frobenius map (which is denoted by Tr).

The standard ISO/IEC 29167-12:2015 “Information technology—Automatic identification and data capture techniques—Part 12: Crypto suite ECC-DH security services for air interface communications” (“ISO standard”) proposes in Section 6.2 the following method which is in general applicable to elliptic curves over binary finite fields GF(2^{m}). In this case:
The data exchanges between the Tag and the Interrogator facilitate simplest possible checking on the Tag that the x-coordinate of the point supplied to the Tag lies on the intended curve (and not on its twist), by sending the pair of values (x, V/x) from the Interrogator to the Tag instead of sending the x and y coordinates of rG; the required check shall then be performed using only two trace computations and a single modular multiplication.

Mathematically, the following facts are checked in such a scenario where no y-coordinate is given. Derived from equation (1), an affine elliptic curve over GF(2^{m}) has the form

$${y}^{2} + xy = {x}^{3} + {ax}^{2} + b \qquad ( 3 )$$

The trace map Tr: GF(2^{m})→GF(2) maps any element of the finite field GF(2^{m}) to either 0 or 1. Additionally, the map has the nice properties that Tr(u+w)=Tr(u)+Tr(w) and Tr(u²)=Tr(u)². Thus, when multiplying (3) with x⁻², we get

$${( \frac{y}{z} )}^{2} + \frac{y}{z} = x + a + b \cdot {x}^{- 2}$$

This quadratic equation has a solution when the right hand side has trace=0. So based on the aforementioned properties of Tr(⋅), this further boils down to the check

$$Tr ( x ) + Tr ( a ) + Tr ( \sqrt{b} \cdot {x}^{- 1} ) = 0 \qquad ( 4 )$$

If it is assumed that for curve used, the parameter a=1 which the case for the standardized NIST curves B-163, B-233, B-283, B-409 and B-571, then additionally Tr(a)=1 results. It is assumed as in that the x-coordinate is the result of a scalar multiplication of the base point r·G (with r≠mod n, n being the group order). Then we can summarize the check of (4) to

$$Tr ( x ) = 1 \qquad ( 5 )$$

$$Tr ( \sqrt{b} \cdot {x}^{- 1} ) = 0.$$

The check described in the ISO standard Section 6.2 has limitations. It gives assurance that at the beginning of the computation the point was valid. A fault attacker might use the long-running scalar multiplication computation to still try and induce a fault such that the final result constitutes a point on the twist, which might be used in an attack.

This is also very relevant if there is a split between two calculations of the same input challenge point for example as in U.S. patent application Ser. No. 18/065,396, filed Dec. 13, 2022, titled “BLINDED SEMI-STATIC ELLIPTIC CURVE DIFFIE-HELLMAN AUTHENTICATION PROTOCOL” which is hereby incorporated by reference for all purposes as if fully set forth herein. Due to restrictions, the integrity information received for the first calculation might not be available anymore during the second calculation.

It thus would be ideal to also perform such a check at the end of the computation. In resource constrained environments, it is very often the case that one has to deal with a reduced register set and any information that is not needed for further computation is overwritten. Thus, the problem is that at the very end of the computation, one only has the projective X and Z coordinate of the scalar multiplication result available.

Depending on the protocol and system requirements, either these projective coordinates will be sent back as a reply or maybe the affine coordinates are expected. In resource constraint requirements, only transferring affine coordinates would be beneficial as it cuts the data transmission in half.

The authentication protocol described herein proposes using the conversion to affine coordinates with a check that the point indeed is still on the elliptic curve and not on the twist. Only the standard projective X and Z coordinate of the result point input are available. The affine x-coordinate then is x=X·Z⁻¹ where the inversion is always the costliest operation compared to squarings and multiplications. Note that this also works in case of Jacobian projective coordinates, where the affine x-coordinate then is x=X·Z⁻².

Instead of inverting Z directly, a single multiplication will be added to the values X, Z and X·Z. The following steps may be carried out to verify that the point is still on the elliptic curve. First calculate the inversion (XZ)⁻¹. This results in the values X, Z, (XZ)⁻¹. Next, square Z, and multiply Z² and (XZ)⁻¹ and the constant V to get \sqrt{b}·x⁻¹. Then, square X, and multiply X² and (XZ)⁻¹ to get x. Next, compute Tr(x) and check that it is 1. Then, compute Tr(\sqrt{b}x⁻¹) and check that it is 0. Note that these steps can be implemented in HW or SW and that the exact order can vary. Thus, by adding two squaring operations, 4 multiplications, and two trace computations, it may be verified that the final result is still a point on the elliptic curve and that no twist-attack has been attempted.

A similar approach for Jacobian projective coordinates would be: Multiply X, Z to get X·Z. Square the result (X·Z)². Now invert to get (X·Z)⁻². Compute X², multiply with X to get X³ and multiply this with (X·Z)⁻² to get the affine x-coordinate x=X·Z⁻². Two consecutive squarings of Z give us Z⁴. This is multiplied with (X·Z)⁻² to get to Z²·X⁻². Multiplying this with X and \sqrt{b} gives us the two values for the trace computations. In total, for Jacobian coordinates we need 4 squarings and 6 multiplications and two trace computations.

Performing complex cryptographic computations in restricted or constrained environments (like small RFID tags) can be particularly challenging. Especially when it comes to public key cryptography because any additional computation results in significant costs. Very often, x-coordinate only implementations are chosen in such environments for efficiency reasons.

The embodiment of a point verification method described herein targets the check of the validity of a scalar multiplication result that is a check whether the final result of the computation is still on the elliptic curve. This is crucial in order to avert so called twist-attacks. This embodiment of the authentication protocol shows how to combine the transformation of a final projective x-coordinate of the result to affine coordinates with very little overhead to allow for efficient checking that the x-coordinate does not belong to a point on the twist.

This embodiment of the authentication protocol seeks to have a point verification for the result where the elliptic curve implementation uses the least hardware-intensive choices possible for a blinded semi-static ECDH protocol used for authentication computations.

A feature includes the combination of the transformation of the scalar multiplication result to affine coordinates with small adaptions such that that the final affine x-coordinate is easily checked that it is indeed is a valid x-coordinate of a point on the curve and not on the twist.

Given the projective x-coordinate of a presumed point on an elliptic curve over a binary field GF(2^{m}), it is sought to have assurance that (X:·:Z) indeed is a valid projective x-coordinate on the elliptic curve. Based on the derived description in equation (5), it can be seen how to check if a point is on the curve if both x and \sqrt{b}x⁻¹ are available.

The question now arises what happens if for some reasons only x is available. Is the check Tr(x)=1 alone sufficient? It is rather straight forward to find a point on the twist which also satisfies Tr(x)=1.

By observing equation (1), it is known that every quadratic twist of (1) has the form

$${y}^{2} + xy = {x}^{3} + ( a + d ) \cdot {x}^{2} + b , \qquad ( 6 )$$

where d satisfies u²+u+d=0 over a quadratic extension field of GF(2^{m}). As above, this can be converted to

$${( \frac{y}{z} )}^{2} + \frac{y}{z} = x + ( a + d ) + b \cdot {x}^{- 2}$$

and thus are left with checking that

$$Tr ( x ) + Tr ( a ) + Tr ( d ) + Tr ( \sqrt{b} \cdot {x}^{- 1} ) = 0.$$

It is again assumed that a=1 (or more generally, Tr(a)=1) and furthermore take into account the fact that d has to have Tr(d)=1 as well (because u²+u+d is irreducible over GF(2^{m})). That means that a point on the quadratic twist will always satisfy that Tr(x) and Tr(\sqrt{b}·x⁻¹) have to be equal, whereas a point on the original curve satisfies that they have opposite sign. This simple calculation just illustrates that the trace of x and \sqrt{b}·x⁻¹ needs to be checked.

Thus, if only an affine x-coordinate is available, it is necessary to compute an inversion and a multiplication in the finite field GF(2^{m}) to be able to check if x is not on the twist.

In resource constrained environments, one usually uses projective coordinates for scalar multiplication formulas in order to avoid inversions. That means, a projective x-only result includes a projective X and Z coordinate. If this needs to be converted to affine coordinates, one computes X·Z⁻¹ or X·Z⁻².

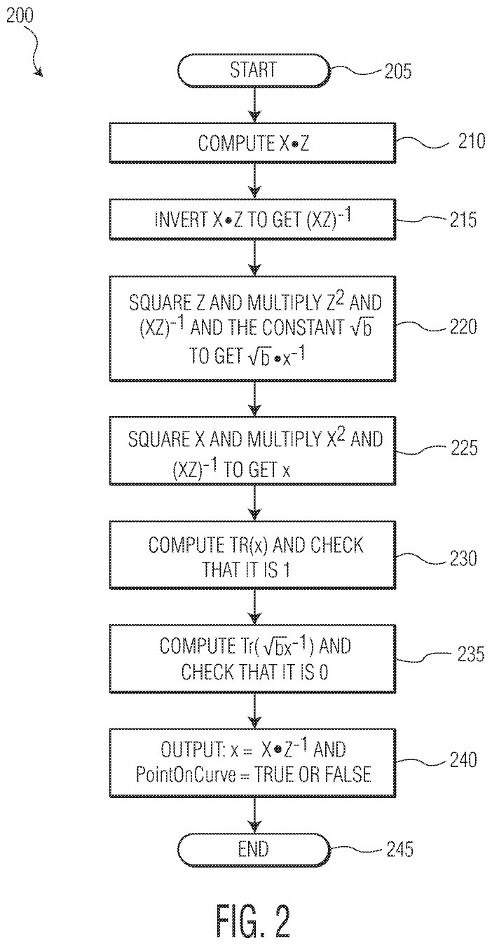

The authentication protocol embodiment proposes a clever way that not only allows us to compute the affine result but it also allows us to verify that the final result is still on the curve and not on the twist with very little overhead. FIG. 2 illustrates a point verification method that checks whether the point is on the elliptic curve. The method 200 receives inputs of X, Z∈GF(2^{m}) and starts at step 205. At step 210 X·Z is computed. Then at step 215 X·Z is inverted to get (XZ)⁻¹. Now the values X, Z, (XZ)⁻¹ are available. At step 220 the method 200 squares Z and multiplies Z² and (XZ)⁻¹ and the constant V to get \sqrt{b}·x⁻¹. Next, at step 225 the method squares X and multiplies X² and (XZ)⁻¹ to get x. At step 230, Tr(x) is computed and the method 200 checks that it is 1. If not then the method 200 declares an error. At step 235 the method computes Tr(\sqrt{b}x⁻¹) and checks that it is 0. If not then the method 200 declares an error. At step 240, the method outputs x=X·Z⁻¹ and PointOnCurve=TRUE or FALSE. The method 200 then ends at step 245. Note that these steps may be implemented in HW or SW and that the exact order may vary.

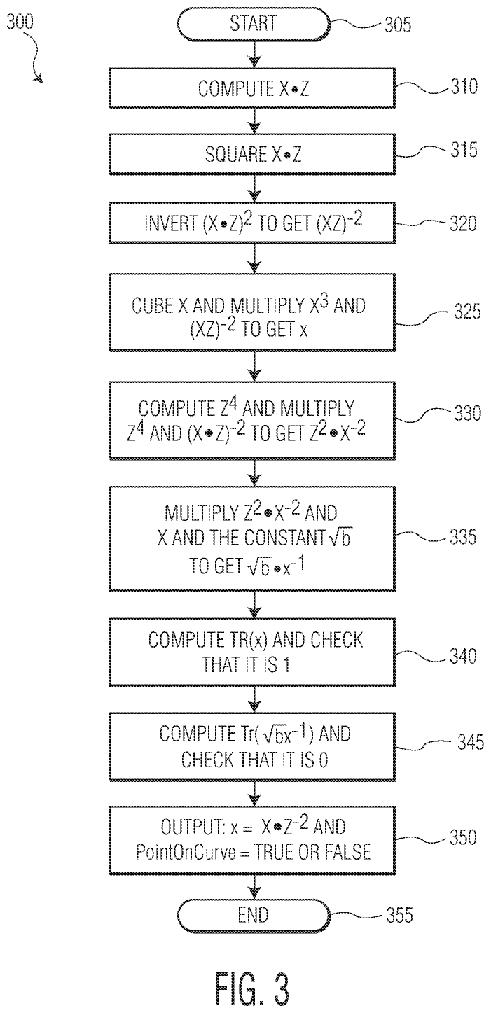

FIG. 3 illustrates a point verification method that checks whether the point is on the elliptic curve for Jacobian projective coordinates. The method 300 receives inputs of X, Z∈GF(2^{m}) and starts at step 305. At step 310 X·Z is computed. Next at step 315 square the result of step 310 to get (X·Z)² Then at step 320 (X·Z)² is inverted to get (XZ)⁻². Now the values X, Z, (XZ)⁻² are available. Next, at step 325 the method 300 cubes X and multiplies X³ and (XZ)⁻² to get the affine x-coordinate x=X·Z⁻². At step 330 Z⁴ is computed by two consecutive squarings of Z. This is multiplied with (X·Z)⁻² to get to Z²·X⁻². At step 335 the method 200 multiplies Z²·X⁻² and X and the constant V to get \sqrt{b}·x⁻¹. At step 340, Tr(x) is computed and the method 300 checks that it is 1. If not then the method 300 declares an error. At step 345 the method computes Tr(\sqrt{b}x⁻¹) and checks that it is 0. If not then the method 300 declares an error. At step 350, the method outputs x=X·Z⁻² and PointOnCurve=TRUE or FALSE. The method 300 then ends at step 355. Note that these steps may be implemented in HW or SW and that the exact order may vary.

The method results in an elliptic curve point validation for x-coordinate only implementations that is efficient by combining the transformation to affine coordinates from projective coordinates with a simple point on curve check. This will detect any fault injected during the authentication process. It also may be implemented in resource constrained applications.

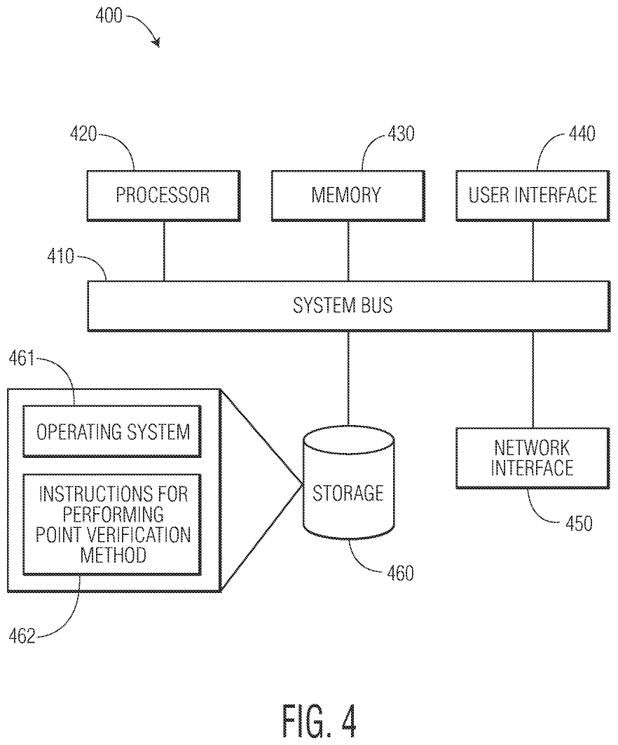

FIG. 4 illustrates an exemplary hardware diagram 400 for implementing an authentication protocol. The exemplary hardware 400 may correspond to either the reader/verifier or the tag/prover of FIG. 1. As shown, the device 400 includes a processor 420, memory 430, user interface 440, network interface 450, and storage 460 interconnected via one or more system buses 410. It will be understood that FIG. 4 constitutes, in some respects, an abstraction and that the actual organization of the components of the device 400 may be more complex than illustrated.

The processor 420 may be any hardware device capable of executing instructions stored in memory 430 or storage 460 or otherwise processing data. As such, the processor 420 may include a microprocessor, microcontroller, graphics processing unit (GPU), neural network processor, field programmable gate array (FPGA), application-specific integrated circuit (ASIC), or other similar devices.

The memory 430 may include various memories such as, for example L1, L2, or L3 cache or system memory. As such, the memory 430 may include static random-access memory (SRAM), dynamic RAM (DRAM), flash memory, read only memory (ROM), or other similar memory devices.

In alternative embodiments, the processor 420 and memory 430 may be replaced by a state machine. This allows for a simpler and more efficient hardware design.

The user interface 440 may include one or more devices for enabling communication with a user. For example, the user interface 440 may include a display, a touch interface, a mouse, and/or a keyboard for receiving user commands. In some embodiments, the user interface 440 may include a command line interface or graphical user interface that may be presented to a remote terminal via the network interface 450.

The network interface 450 may include one or more devices for enabling communication with other hardware devices. For example, the network interface 450 may include a network interface card (NIC) configured to communicate according to the Ethernet protocol or other communications protocols, including wireless protocols. Additionally, the network interface 450 may implement a TCP/IP stack for communication according to the TCP/IP protocols. Various alternative or additional hardware or configurations for the network interface 450 will be apparent.

The storage 460 may include one or more machine-readable storage media such as read-only memory (ROM), random-access memory (RAM), magnetic disk storage media, optical storage media, flash-memory devices, or similar storage media. In various embodiments, the storage 460 may store instructions for execution by the processor 420 or data upon with the processor 430 may operate. For example, the storage 460 may store a base operating system 461 for controlling various basic operations of the hardware 400. Storage 460 may include instructions 463 for carrying out the point verification method described herein.

It will be apparent that various information described as stored in the storage 460 may be additionally or alternatively stored in the memory 430. In this respect, the memory 430 may also be considered to constitute a “storage device” and the storage 460 may be considered a “memory.” Various other arrangements will be apparent. Further, the memory 430 and storage 460 may both be considered to be “non-transitory machine-readable media.” As used herein, the term “non-transitory” will be understood to exclude transitory signals but to include all forms of storage, including both volatile and non-volatile memories.

The system bus 410 allows communication between the processor 420, memory 430, user interface 440, storage 460, and network interface 450.

While the host device 400 is shown as including one of each described component, the various components may be duplicated in various embodiments. For example, the processor 420 may include multiple microprocessors that are configured to independently execute the methods described herein or are configured to perform steps or subroutines of the methods described herein such that the multiple processors cooperate to achieve the functionality described herein. Further, where the device 400 is implemented in a cloud computing system, the various hardware components may belong to separate physical systems. For example, the processor 420 may include a first processor in a first server and a second processor in a second server.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. An elliptic curve point validation method, comprising:
receiving a standard projective X and Z coordinate on an elliptic curve;
computing X·Z;
inverting X·Z to get (XZ)⁻¹;
multiplying Z², (XZ)⁻¹, and a constant VT resulting in \sqrt{b}·x⁻¹, where b is a constant of the elliptic curve;
multiplying X² and (XZ)⁻¹ resulting in x;
computing Tr(x) and checking that it has a value of 1, where Tr(⋅) is a trace of Frobenius map that maps an input to a value of 0 or 1;
computing Tr(\sqrt{b}x⁻¹) and checking that it has a value of 0; and
outputting x and a PointOnCurve value, where the PointOnCurve value indicates whether x is on the elliptic curve.

2. The method of claim 1, further comprising setting PointOnCurve to true when Tr(x) has a value of 1 and Tr(\sqrt{b}x⁻¹) has a value of 0.

3. The method of claim 1, further comprising setting PointOnCurve to false when either Tr(x) has a value of 1 or Tr(\sqrt{b}x⁻¹) has a value of 0.

4. The method of claim 1, further comprising calculating a square of X.

5. The method of claim 1, further comprising calculating a square of Z.

6. A data processing system comprising instructions embodied in a non-transitory computer readable medium, the instructions for an elliptic curve point validation method based on an elliptic curve in a processor, the instructions, comprising:
receiving a projective X and Z coordinate on the elliptic curve;
computing X·Z;
inverting X·Z to get (XZ)⁻¹;
multiplying Z², (XZ)⁻¹, and a constant VT resulting in \sqrt{b}·x⁻¹, where b is a constant of the elliptic curve;
multiplying X² and (XZ)⁻¹ resulting in x;
computing Tr(x) and checking that it has a value of 1, where Tr(⋅) is a trace of Frobenius map that maps an input to a value of 0 or 1;
computing Tr(\sqrt{b}x⁻¹) and checking that it has a value of 0; and
output x and a PointOnCurve value, where the PointOnCurve value indicates whether x is on the elliptic curve.

7. The data processing system of claim 6, further comprising setting PointOnCurve to true when Tr(x) has a value of 1 and Tr(\sqrt{b}x⁻¹) has a value of 0.

8. The data processing system of claim 6, further comprising setting PointOnCurve to false when either Tr(x) has a value of 1 or Tr(\sqrt{b}x⁻¹) has a value of 0.

9. The data processing system of claim 6, further comprising calculating a square of X.

10. The data processing system of claim 6, further comprising calculating a square of Z.

11. An elliptic curve point validation method, comprising:
receiving a Jacobian projective X and Z coordinate on an elliptic curve;
computing (X·Z)²;
inverting (X·Z)² to get (XZ)⁻²;
multiplying X³ and (XZ)⁻² resulting in x;
multiplying Z⁴ and (XZ)⁻² to get Z²·X⁻²;
multiplying Z²·X⁻² with X and a constant \sqrt{b} resulting in \sqrt{b}·x⁻¹, where b is a constant of the elliptic curve;
computing Tr(x) and checking that it has a value of 1, where Tr(⋅) is a trace of Frobenius map that maps an input to a value of 0 or 1;
computing Tr(\sqrt{b}x⁻¹) and checking that it has a value of 0; and
outputting x and a PointOnCurve value, where the PointOnCurve value indicates whether x is on the elliptic curve.

12. The method of claim 11, further comprising setting PointOnCurve to true when Tr(x) has a value of 1 and Tr(\sqrt{b}x⁻¹) has a value of 0.

13. The method of claim 11, further comprising setting PointOnCurve to false when either Tr(x) has a value of 1 or Tr(\sqrt{b}x⁻¹) has a value of 0.

14. The method of claim 11, further comprising calculating a cube of X.

15. The method of claim 11, further comprising squaring Z twice.

16. A data processing system comprising instructions embodied in a non-transitory computer
receiving a projective X and Z coordinate on an elliptic curve;
computing (X·Z)²;
inverting (X·Z)² to get (XZ)⁻²;
multiplying X³ and (XZ)⁻² resulting in x;
multiplying Z⁴ and (XZ)⁻² to get Z²·X⁻²;
multiplying Z²·X⁻² with X and a constant \sqrt{b} resulting in \sqrt{b}·x⁻¹, where b is a constant of the elliptic curve;
computing Tr(x) and checking that it has a value of 1, where Tr(⋅) is a trace of Frobenius map that maps an input to a value of 0 or 1;
computing Tr(\sqrt{b}x⁻¹) and checking that it has a value of 0; and
outputting x and a PointOnCurve value, where the PointOnCurve value indicates whether x is on the elliptic curve.

17. The data processing system of claim 16, further comprising setting PointOnCurve to true when Tr(x) has a value of 1 and Tr(\sqrt{b}x⁻¹) has a value of 0.

18. The data processing system of claim 16, further comprising setting PointOnCurve to false when either Tr(x) has a value of 1 or Tr(\sqrt{b}x⁻¹) has a value of 0.

19. The data processing system of claim 16, further comprising calculating a cube of X.

20. The data processing system of claim 16, further comprising squaring Z twice.
